(19) United States
(12) Patent Application Publication
(10) Pub. No.: US 2016/0095177 A1
(43) Pub. Date: Mar. 31, 2016

(54) POWER TOOL

(71) Applicant: CHERVON INTELLECTUAL PROPERTY LIMITED, Road Town (VG)

(72) Inventors: Wu Chen, Nanjing (CN); Fengqin Zhou, Nanjing (CN)

(21) Appl. No.: 14/863,658

(22) Filed: Sep. 24, 2015

(30) Foreign Application Priority Data
Sep. 30, 2014 (CN) 201410521480.6
Sep. 30, 2014 (CN) 201420576232.7

(51) Int. Cl. H05B 33/08; H05B 37/02

(52) U.S. Cl. CPC H05B 33/0815; H05B 37/02

(57) ABSTRACT

A power tool includes a function device for performing the main function of the power tool, a positive connecting terminal for connecting with a positive pole of a power supply, a negative connecting terminal for connecting with a negative pole of the power supply, a main switch for controlling the connection between the output terminal and the power supply, an illumination circuit having at least one illumination member, an illumination control circuit for controlling the connection between the illumination member and the power supply, and a delay circuit for controlling the illumination control circuit so that the illumination member can still illuminate when the main function of the power tool is shut off.

### RELATED APPLICATION INFORMATION

This application claims the benefit of CN 201410521480.6, filed on Sep. 30, 2014, and CN 201420576232.7, filed on Sep. 30, 2014, the disclosures of which are incorporated herein by reference in their entirety.

### FIELD OF THE DISCLOSURE

The present disclosure relates generally to power tools.

### BACKGROUND OF THE DISCLOSURE

Power tools are known to have an illumination function for working in darkness, and particularly where the illumination function is controlled by triggers which are capable of controlling the main function of the power tool. Thus, when a user operates the trigger to perform the main function of the power tool, the illumination function of the power tool performs synchronously and, when the user operates the trigger to end the main function of the power tool, the illumination function of the power tool ends synchronously.

But, in some cases for example, when a user needs to reload the tool accessory or aim at the target area, the user still needs the illumination function after the main function of the power tool has ended.

The statements in this section merely provide background information related to the present disclosure and may not constitute prior art.

### SUMMARY

The present disclosure provides a power tool that mainly comprises a function device for performing the main function of the power tool, a positive connecting terminal for connecting with a positive pole of a power supply, a negative connecting terminal for connecting with a negative pole of the power supply, a main switch for controlling the connection between the output terminal and the power supply, an illumination circuit having at least one illumination member, an illumination control circuit for controlling the connection between the illumination member and the power supply, and a delay circuit for controlling the illumination control circuit.

In some cases, the delay circuit may comprise a stored energy circuit for storing electrical energy when the main switch disconnects the outputting terminal from the power supply so as to causes the illumination control circuit to disconnect the illumination member from the power supply within a certain time after the main switch disconnects the outputting terminal from the power supply.

In some cases, the delay circuit may comprise a capacitor for accumulating the electrical energy, a detecting circuit for detecting the voltage of the capacitor, and a capacitor control circuit for controlling the capacitor where the capacitor connects with the detecting circuit and the capacitor control circuit.

In some cases, the capacitor control circuit may comprise a first switch having a first connection electrode connecting to the positive pole of the capacitor, a second connection electrode connecting to the negative pole of the capacitor, and a first control electrode for controlling the connection between the first connection electrode and the second connection electrode where the first control electrode connects to the output terminal.

In some cases, the illumination control circuit may comprise a second switch having a third connection electrode connecting to the positive connecting terminal, a fourth connection electrode connecting to the illumination circuit, and a second control electrode for controlling the connection between the third connection electrode and the fourth connection electrode.

In some cases, the detecting circuit may comprise a first resistor and a second resistor which are in series connection and the second control electrode connects the end of the first resistor which connects with the second resistor.

In some cases, the illumination control circuit may comprise a second switch having a third connection electrode for introducing current from the positive connecting terminal, a fourth connection electrode for outputting current to the illumination circuit, and a second control electrode for controlling the connection between the third connection electrode and the fourth connection electrode where the illumination circuit may be connected between the fourth connection electrode and the negative connecting terminal.

In some cases, the illumination member may be a light-emitting diode.

In some cases, the first switch may be one of a transistor and a field-effect transistor.

In some cases, the first switch may be one of a transistor and a field-effect transistor and the second switch may be one of a transistor and a field-effect transistor.

Further areas of applicability will become apparent from the description provided herein. It should be understood that the description and specific examples are intended for purposes of illustration only and are not intended to limit the scope of the invention hereinafter claimed.

### BRIEF DESCRIPTION OF THE DRAWINGS

FIG. 1 is a circuit diagram of an exemplary configuration of a power tool according the present disclosure.

The drawing described herein is provided only to illustrate an exemplary implementation, but not all possible implementations, of the subject system and, as such, is not intended to limit the scope of the claims hereinafter presented.

### DETAILED DESCRIPTION

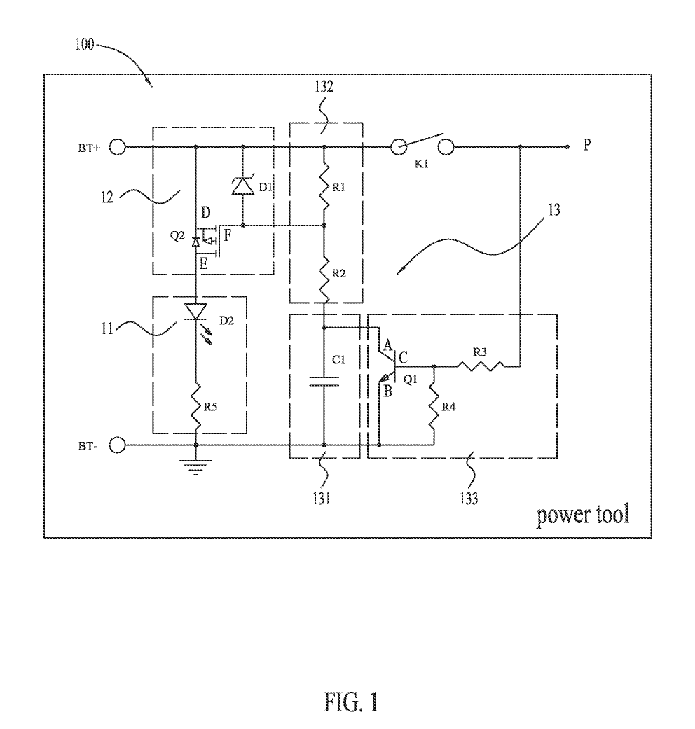

An exemplary power tool 100 as shown in FIG. 1 comprises a function device, a positive connecting terminal BT+, a negative connecting terminal BT−, a main switch K1, an output terminal P, an illumination circuit 11, and a delay circuit 13.

The function device is used to perform the main function of the power tool 100, and when the function device connects with a power supply, the function device performs the main function such as changing the electrical energy into mechanical energy or luminous energy. By way of example, the function device may be a conventionally known electric motor or laser generator.

The positive connecting terminal BT+ and the negative connecting terminal BT− are configured to connect to a power supply, particularly a battery pack. The positive connecting terminal BT+ and the negative connecting terminal BT− will introduce the electrical energy into the power tool 100 so as to power the function device and other parts of the power tool 100.

The output terminal P connects with the function device and is used to output electrical energy to the function device.

Users can operate the main switch K1 to control the connection between the positive connecting terminal BT+ and the output terminal P. When the main switch K1 shut off the connection, the power supply, which is connected with the positive connecting terminal BT+ and the negative connecting terminal BT−, stops the output of electrical energy to the function device. Specifically, the main switch K1 may be configured as a trigger switch.

The illumination function of the power tool 100 is performed by the illumination circuit 11, and the illumination circuit 11 has at least one illumination member D2. The illumination member D2 connects to the positive connecting terminal BT+ by the illumination control circuit 12.

The illumination control circuit 12 is capable of controlling the illumination circuit 11.

The illumination member D2 illuminates by using power from the power supply which is connected with the positive connecting terminal BT+ and the negative connecting terminal BT− when the illumination control circuit 12 connects the power supply to the illumination circuit 11.

Particularly the illumination member D2 is a light-emitting diode.

The delay circuit 13 is used for performing the delay function so as to keep the illumination member D2 illuminated for a certain period of time after the main switch K1 disconnects the power supply from the function device.

The delay circuit 13 includes a stored energy circuit 131 for storing the electrical energy from the power supply when the main switch K1 disconnects the outputting terminal from the power supply so as to causes the illumination control circuit 12 to disconnect the illumination member D2 from the power supply at a certain time after the main switch K1 disconnects the outputting terminal from the power supply.

The stored energy circuit 131 includes a capacitor C1 for accumulating the electrical energy.

The stored energy circuit 131 starts accumulating the electrical energy when the main switch K1 disconnects the outputting terminal from the power supply. When the amount of electrical energy of the capacitor C1 reaches a preset level, the voltage of the capacitor C1 causes the delay circuit 13 to generate a control signal to the illumination control circuit 12. When the illumination control circuit 12 receives the control signal, the illumination control circuit 12 disconnects the illumination member D2 from the power supply

The delay circuit 13 also includes a detecting circuit 132 and a capacitor control circuit 133.

The detecting circuit 132 is used for detecting the voltage of the capacitor C1. Particularly, the detecting circuit 132 detects the voltage of the high-voltage end of the capacitor C1.

The capacitor control circuit 133 is used for controlling the capacitor C1 and the capacitor C1 connects with the detecting circuit 132 and the capacitor control circuit 133.

Specifically, the capacitor control circuit 133 comprises a first switch Q1. The first switch Q1 has a first connection electrode A, a second connection electrode B, and a first control electrode C.

The first connection electrode A connects to the positive pole of the capacitor C1 (the high-voltage end of the capacitor C1).

The second connection electrode B connects to the negative pole of the capacitor C1 (the low-voltage end of the capacitor C1).

The first control electrode C is used for controlling the connection between the first connection electrode A and the second connection electrode B.

By changing the voltage signal, the first control electrode C can connect the first connection electrode A to the second connection electrode B and disconnect the first connection electrode A from the second connection electrode B.

The first control electrode C connects to the output terminal P so as to control the first switch Q1 according to the voltage signal of the output terminal P.

Particularly, the first switch Q1 is one of a transistor and a field-effect transistor.

Otherwise, the detecting circuit 132 comprises a first resistor R1 and a second resistor R2 which are in series connection.

The second control electrode F connects the end of the first resistor R1 which connects with the second resistor R2.

The illumination control circuit 12 comprises a second switch Q2.

Similar to the first switch Q1, the second switch Q2 has a third connection electrode D, a fourth connection electrode E and a second control electrode F.

The third connection electrode D connects to the positive connecting terminal BT+ and is capable of introducing current from positive connecting terminal BT+.

The fourth connection electrode E connects to the illumination circuit 11 and is capable of outputting current to the illumination circuit 11.

The second control electrode F is used for controlling the connection between the third connection electrode D and the fourth connection electrode E.

The illumination circuit 11 is connected between the fourth connection electrode E and the negative connecting terminal BT−.

Referring to FIG. 1, when the main switch K1 is on, the positive connecting terminal BT+ connects the function device so as to power the function device, the first switch Q1 makes the two ends of the capacitor C1 connect, the second switch Q2 makes the third connection electrode D and fourth connection electrode E connect, and the illumination member D2 illuminates. When the main switch K1 is off, the positive connecting terminal BT+ disconnects the function device so the function device shuts off, the first switch Q1 disconnects the two ends of the capacitor C1, and the capacitor C1 is being charged. After a certain period, the voltage signal of the high-voltage end of the capacitor C1 makes the second switch Q2 disconnect the illumination member D2 from the positive connecting terminal BT+ so as to shut off the power supply of the illumination member D2.

The above illustrates and describes basic principles, main features and advantages of the present invention. Those skilled in the art should appreciate that the above embodiments do not limit the present invention in any form. Technical solutions obtained by equivalent substitution or equivalent variations all fall within the scope of the present invention.

What is claimed is:

1. A power tool, comprising:
a positive connecting terminal for connecting with a positive pole of a power supply;
a negative connecting terminal for connecting with a negative pole of the power supply;
a main switch for controlling the connection between the output terminal and the power supply for turning on and off a main function device of the power tool;
an illumination circuit having at least one illumination member;
an illumination control circuit for controlling the connection between the illumination member and the power supply; and
a delay circuit for controlling the illumination control circuit;
wherein the delay circuit comprises a stored energy circuit for storing electrical energy when the main switch disconnects the outputting terminal from the power supply so as to causes the illumination control circuit to disconnect the illumination member from the power supply at a certain time after the main switch disconnects the outputting terminal from the power supply.

2. The power tool according to claim 1, wherein the stored energy circuit comprises a capacitor for accumulating the electrical energy, the delay circuit further comprises a detecting circuit for detecting the voltage of the capacitor and a capacitor control circuit for controlling the capacitor, and the capacitor connects with the detecting circuit and the capacitor control circuit.

3. The power tool according to claim 2, wherein the capacitor control circuit comprises a first switch having a first connection electrode connecting to the positive pole of the capacitor, a second connection electrode connecting to the negative pole of the capacitor, and a first control electrode for controlling the connection between the first connection electrode and the second connection electrode and wherein the first control electrode connects to the output terminal.

4. The power tool according to claim 2, wherein the illumination control circuit comprises a second switch having a third connection electrode connecting to the positive connecting terminal, a fourth connection electrode connecting to the illumination circuit, and a second control electrode for controlling the connection between the third connection electrode and the fourth connection electrode.

5. The power tool according to claim 4, wherein the detecting circuit comprises a first resistor and a second resistor which are connected in series and the second control electrode connects to an end of the first resistor which connects with the second resistor.

6. The power tool according to claim 2, wherein the illumination control circuit comprises a second switch having a third connection electrode for introducing current from the positive connecting terminal, a fourth connection electrode for outputting current to the illumination circuit, and a second control electrode for controlling the connection between the third connection electrode and the fourth connection electrode and wherein the illumination circuit is connected between the fourth connection electrode and the negative connecting terminal.

7. The power tool according to claim 1, wherein the illumination member is a light-emitting diode.

8. The power tool according to claim 1, wherein the first switch is one of a transistor and a field-effect transistor and wherein the second switch is one of a transistor and a field-effect transistor.
